(19) United States
(12) Patent Application Publication
(10) Pub. No.: US 2010/0308191 A1
(43) Pub. Date: Dec. 9, 2010

(54) DVT PUMP BRACKET

(75) Inventor: Michael D. Rydzinski, Independence, OH (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: The Cleveland Clinic Foundation

(21) Appl. No.: 12/797,006

(22) Filed: Jun. 9, 2010

Related U.S. Application Data
(60) Provisional application No. 61/185,295, filed on Jun. 9, 2009.

(51) Int. Cl. F16M 13/02; B65D 85/00

(52) U.S. Cl. 248/224.8; 206/320

(57) ABSTRACT

A bracket for securing a pump having a plurality of fluid communication tubes and at least one pre-existing mounting opening to pre-existing openings in the frame of a hospital includes a base that has at least one opening aligned with the at least one pre-existing mounting opening of the pump for securing the base to the pump. At least one mounting arm is connected to the base and includes at least one opening aligned with the at least one pre-existing opening in the hospital bed frame.

### RELATED APPLICATION

The present invention claims priority to U.S. Provisional Application Ser. No. 61/185.295, filed Jun. 9, 2009, the entirety of which is incorporated herein by reference in its entirety.

### TECHNICAL FIELD

The present invention relates to specialty beds, their controls, and mounting brackets and, in particular, to a mounting bracket for a deep vein thrombosis pump.

### BACKGROUND OF THE INVENTION

Deep vein thrombosis (DVT) occurs when a blood clot forms in a deep vein. It most commonly happens in the deep veins of the lower leg, and can spread up to the deep veins in the thigh. Rarely, it can develop in other deep veins, for example in the arm. Pumps have been developed in order to treat persons diagnosed with DVT in both hospital and ambulatory settings.

In the hospital setting, the pumps are placed at the foot of the bed and are held in place with a pad lock and wire for security purposes. This mounting practice has several disadvantages. Namely, the wire is obtrusive and the mounting is generally unattractive and cluttered. There is therefore a need in the art to provide a way of mounting DVT pumps to the hospital bed in a manner that is both discrete and aesthetically pleasing.

Moreover, some hospital beds include controls for the bed that can be used to articulate or otherwise operate the bed and/or perform tests on the patient. Alternatively, the bed portion to which the pump is often secured is sometimes removed, leading to other pump mounting complications. In any case, it is desirable to ensure that the bed controls are both accessible and operable. Accordingly, there is a need in the art for a protective device for these bed controls.

### SUMMARY OF THE INVENTION

In accordance with the present invention a bracket for securing a pump having a plurality of fluid communication tubes and at least one pre-existing mounting opening to pre-existing openings in the frame of a hospital includes a base that has at least one opening aligned with the at least one pre-existing mounting opening of the pump for securing the base to the pump. A mounting arm is connected to the base and includes at least one opening aligned with the at least one pre-existing opening in the hospital bed frame.

In accordance with another aspect of the present invention a bracket for securing a pump having a plurality of fluid communication tubes and at least one pre-existing mounting opening to pre-existing openings in the frame of a hospital includes a base that has at least one opening aligned with the at least one pre-existing mounting opening of the pump for securing the base to the pump. A mounting arm includes at least one opening aligned with the at least one pre-existing opening in the hospital bed frame. A support arm extends from the base and connects the mounting arm to the base.

In accordance with another aspect of the present invention an apparatus for protecting the touch screen of a touch screen control device includes a substantially U-shaped frame configured to overlay the periphery of the touch screen control device. A hinge is secured to the frame and positioned adjacent to the touch screen and a protective cover is secured to the hinge. The cover is pivotable relative to the frame from a first position overlying and protecting the touch screen to a second position in which the touch screen is exposed.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of a mounting bracket and DVT pump in accordance with the present invention;

FIG. 2 is a perspective view of the mounting bracket of FIG. 1;

FIG. 3 is a side view of the mounting bracket of FIG. 1;

FIG. 4 is a schematic illustration of the mounting bracket of FIG. 1 securing a DVT pump to a hospital bed;

FIG. 5 is an enlarged view of a portion of FIG. 4;

FIG. 6 is a photograph of the mounting bracket of FIG. 1 mounted to the hospital bed;

FIG. 7 is a schematic illustration of an embodiment of the mounting bracket of the present invention;

FIG. 8 is a rear view of the mounting bracket of FIG. 7 secured to a DVT pump;

FIG. 9 is a front view of the mounting bracket of FIG. 7;

FIG. 10 is a photograph of the mounting bracket of FIG. 7 securing the DVT pump to a hospital bed;

FIG. 11 is a schematic illustration of another embodiment of the mounting bracket of the present invention;

FIG. 12 is a perspective view of the mounting bracket of FIG. 11;

FIG. 13 is a schematic illustration of another embodiment of the mounting bracket of the present invention;

FIG. 14 is a schematic illustration of another embodiment of the mounting bracket of the present invention;

FIG. 15 is a schematic illustration of a protective device for a hospital bed having a touch screen control system;

FIG. 16 is a schematic illustration of the control system of FIG. 15 having a protective device in accordance with the present invention;

FIG. 17 is a rear view of the control system of FIG. 16; and

FIG. 18 is a schematic illustration of the control system of FIG. 16 in which the protective device is in an upright position.

### DETAILED DESCRIPTION

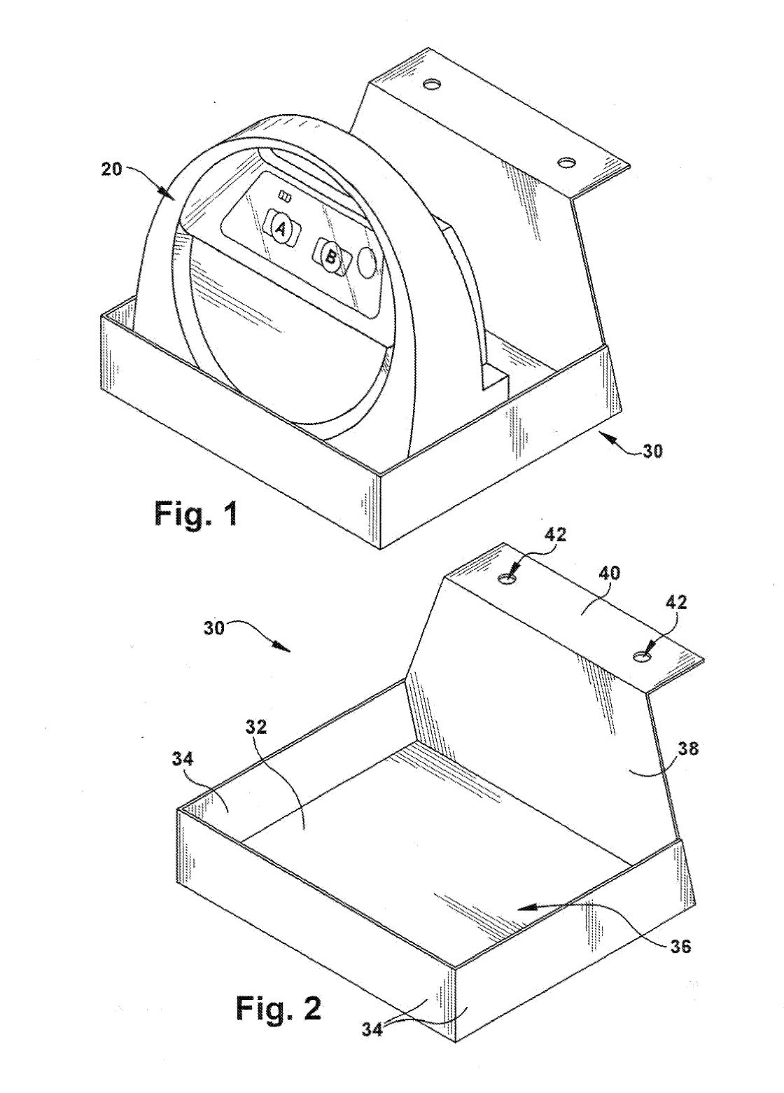

The present invention relates to mounting brackets and, in particular, relates to a mounting bracket for a deep vein thrombosis (DVT) pump. FIGS. 1-3 illustrate a mounting bracket 30 for securing a DVT pump 20 to a hospital bed in accordance with the present invention. The DVT pump 20 can be any commercially available DVT pump such as, for example, an SCD Express™ DVT pump, manufactured by Kendall of Mansfield, Mass.

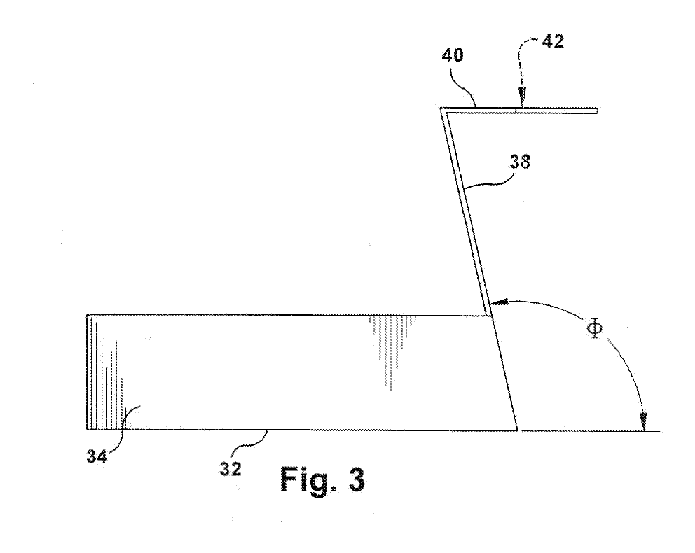

The bracket 30 includes a generally rectangular base 32 and a plurality of walls 34 that extend away from the base and collectively define an interior space 36. A support arm 38 extends from the base 32 at an angle illustrated at Φ (FIG. 3). Although the angle Φ is illustrated as being obtuse, those having ordinary skill will appreciate that the angle Φ may be perpendicular or acute. A mounting arm 40 extends from the support arm 38 and substantially parallel to the base 32. At least one opening 42 extends through the mounting arm 40 and is configured to receive a fastener (not shown) for securing the bracket 30 to a hospital bed. The bracket 30 is constructed of a rigid material such as metal, plastic or combinations thereof.

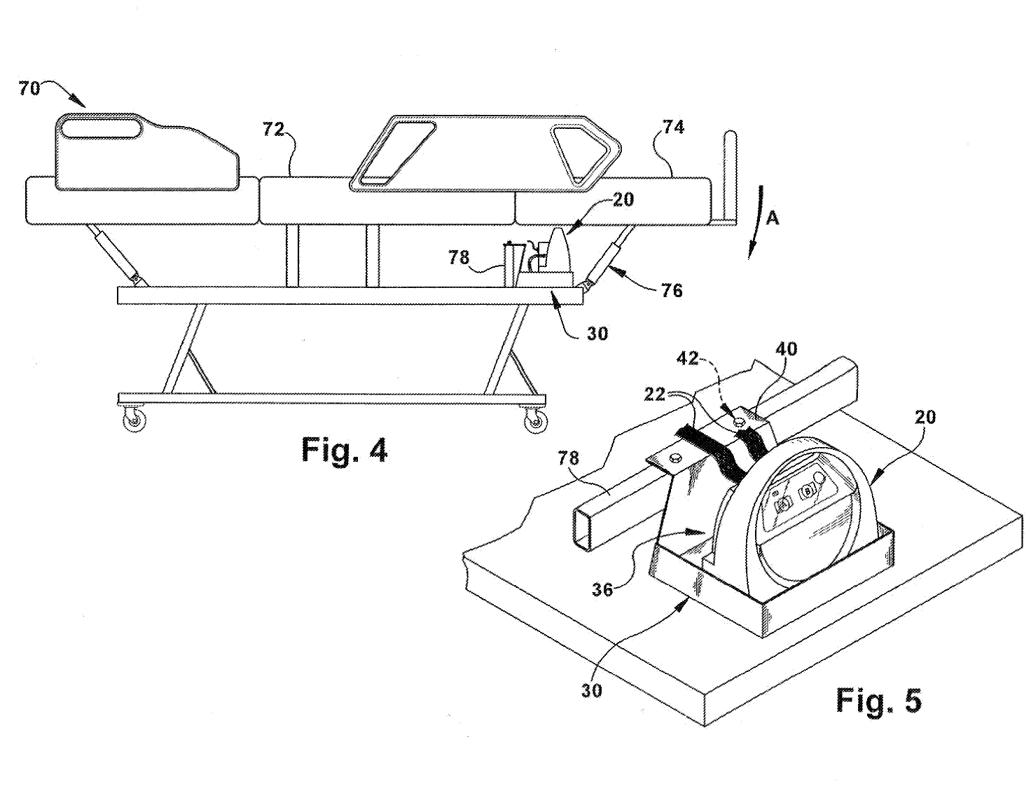

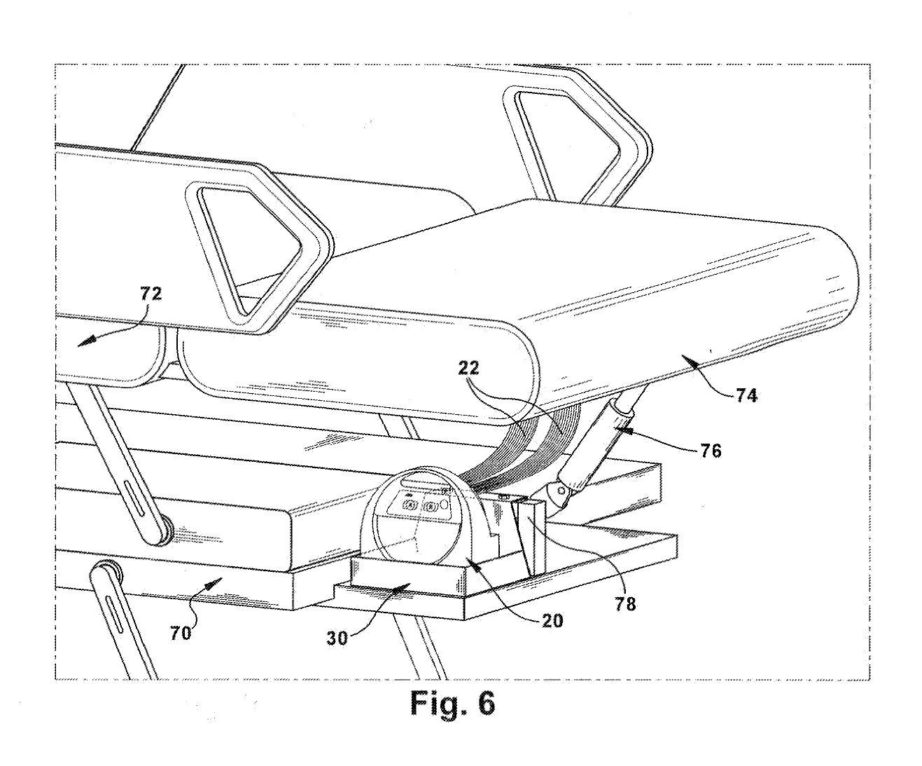

As shown in FIGS. 4-6, the interior space 36 of the bracket 30 receives the DVT pump 20 (see also FIG. 1) such that the pump is positioned between the support arm 38 and the walls 34 extending from the base 32. The base 32 may include one or more openings (not shown) that receive fasteners for securing the bracket 30 to the bottom of the DVT pump 20. The openings may be sized, shaped, and positioned to correspond with pre-existing openings in the bottom of the DVT pump 20. In other words, the mounting bracket 30 can be secured to the DVT pump 20 without modifying or otherwise altering the functionality of the pump.

Once the DVT pump 20 is positioned on the base 32 of the mounting bracket 30, the pump can be secured to a hospital bed 70. The bed 70 includes a main portion 72 for receiving the patient's body and an end portion 74 for receiving the patient's legs and feet. A hydraulic unit 76 controls movement of the end portion 74 relative to the main portion 72 in the direction indicated by arrow A.

In accordance with the present invention, the bracket 30 allows the DVT pump 20 to be secured to the underside of the bed 70 without altering the pump or the bed in any way. In particular, the openings 42 in the mounting portion 40 of the bracket 30 are sized and configured to correspond with pre-existing openings (not shown) in the frame 78 of the bed 70. The bracket 30, therefore, by using existing bolt holes in the frame 78 of the bed 70, eliminates the need to drill extra holes in the frame.

Furthermore, the bracket 30 and, thus, the DVT pump 20 can be mounted to the underside of the bed 70 in a location that is out of sight and that does not inhibit movement of the end portion 74 of the bed relative to the main portion 72. Moreover, fasteners used to secure the DVT pump 20 to the bracket 30 and/or the fasteners used to secure the bracket to the frame 78 of the bed 70 may be security fasteners in order to securely mount the bracket and the pump in place.

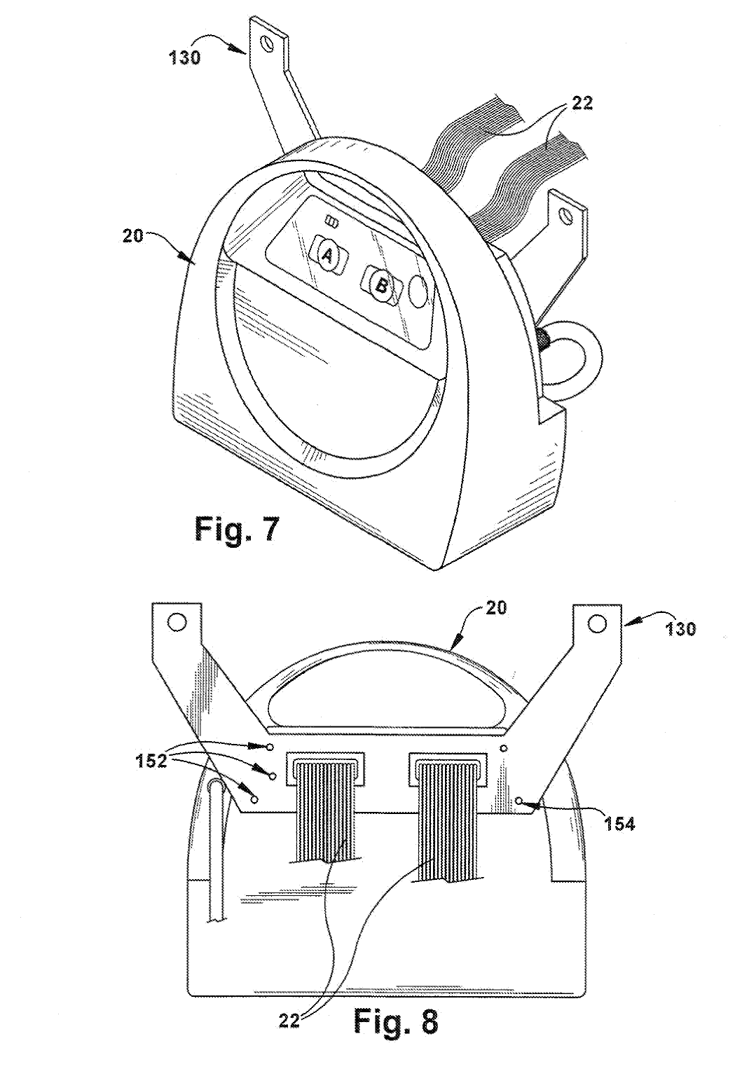

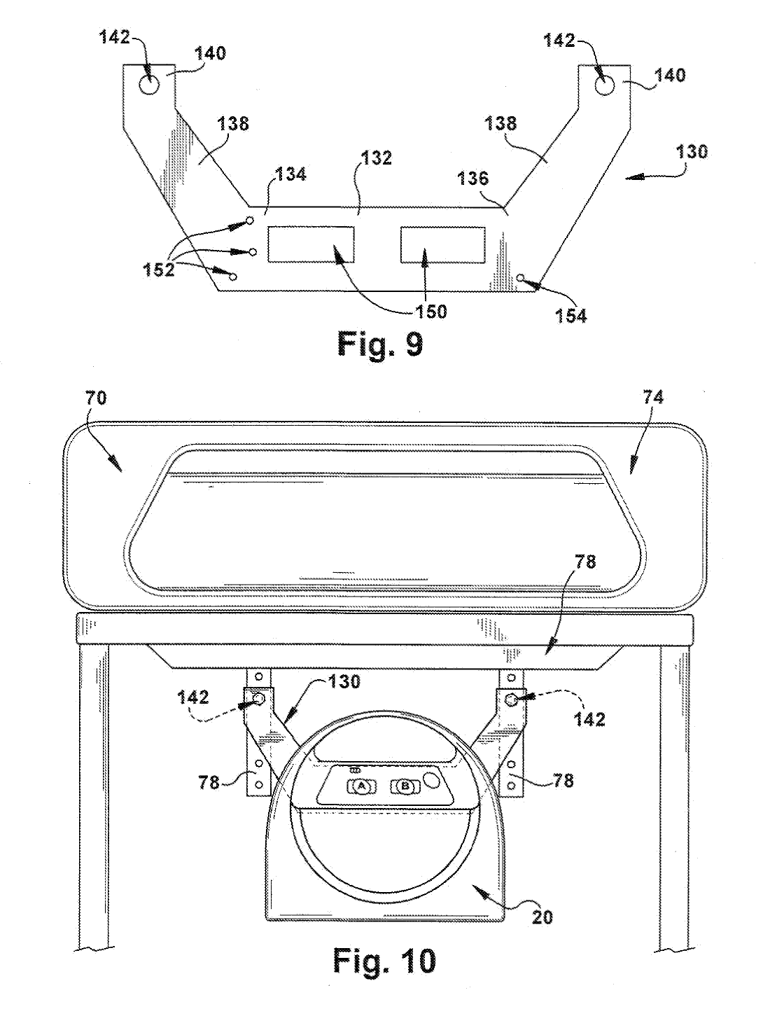

FIGS. 7-10 illustrate a mounting bracket 130 for mounting the DVT pump 20 to the hospital bed 70 in accordance with another aspect of the present invention. The mounting bracket 130 includes a generally rectangular base 132 that has a first end 134 and a second end 136. A support arm 138 extends from one or each end 134, 136 of the base 132. Each support arm 138 terminates with a mounting arm 140 that has an opening 142 extending entirely therethrough. The bracket 130 therefore has a substantially U-shaped configuration and is constructed of a rigid material such as metal, plastic or combinations thereof.

The base 132 of the bracket 130 includes at least one opening 150 for receiving tubing 22 that extends from the DVT pump 20 and connects to the patient (not shown). The at least one opening 150 may be rectangular, square, circular or otherwise sized and shaped to allow the tubing 22 from the DVT pump 20 to pass through the bracket 130 to the patient without crimping the tubing 22 or otherwise impeding connection between the pump and the patient. The edges of the base 132 defining the opening(s) 150 may be rounded (not shown) or otherwise made smooth such that the tubing 22 does not abrade against the edges of each opening.

The base 132 further includes at least one opening 152 in the first end 134 and at least one opening 154 in the second end 136. The openings 152 and 154 are sized, positioned, and shaped to correspond with pre-existing threaded openings in the DVT pump 20. This configuration allows fasteners (not shown) to extend through the openings 152 and 154 in the bracket 130 and into engagement with the DVT pump 20 to secure the bracket to the pump without altering the pump in any way. The fasteners can be security screws to prevent the DVT pump 20 from being removed from the bracket 130 once the pump is mounted to the bed 70 to prevent theft

As shown in FIG. 10, once the DVT pump 20 is secured to the bracket 130, the openings 142 in the mounting arms 140 of the bracket are aligned with pre-existing openings in the frame 78 of the hospital bed 70 to mount the pump to the bed. To facilitate this alignment, the support arms 138 and the mounting arms 140 may be configured to mimic the geometry of portions of the bed frame 78: Accordingly, the support arms 138 and the mounting arms 140 may have a symmetric or asymmetric configuration relative to the base 132 depending on the geometry of the bed frame 78. Due to the ability of the support arms 138 and the mounting arms 140 to mimic the geometry of the frame 78, the DVT pump 20 may be mounted in any number of positions on the frame. For example, as shown in FIG. 10, the DVT pump 20 may be mounted to the underside of the bed 70 in a position closer to the end portion 74 and facing away from the end portion for easy access. The DVT pump 20 could likewise be mounted at a position along the underside of the bed 70 and facing outwards to place the pump out of the way without compromising the efficacy of the pump or movement of the bed.

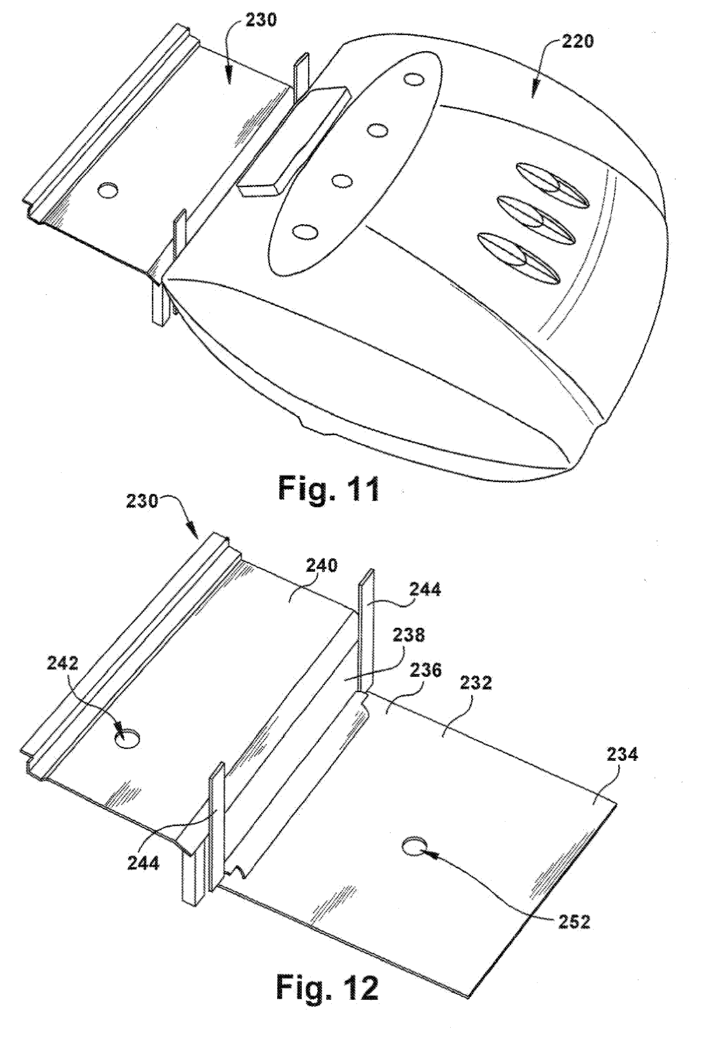

FIGS. 11-12 illustrate a mounting bracket 230 for mounting a DVT pump 220 to the hospital bed 70 in accordance with another aspect of the present invention. The bracket 230 has a generally rectangular shape and includes a base 232 that has a first end 234 and a second end 236. The bracket 230 is constructed of any rigid material such as metal, plastic or combinations thereof.

A support arm 238 and at least one retaining arm 244 extend from the second end 236 of the base 232. In particular, a plurality of retaining arms 244 may he positioned about the periphery of the base 232 is a manner that surrounds a DVT pump 220 placed thereon. A mounting arm 240 extends from the support arm 238 such that, in combination, the mounting arm and the base 232 exhibit a tiered construction. In this construction, the mounting arm 240 may extend parallel to the base 232 or may extend at an angle relative to the base. The mounting arm 240 includes at least one opening 242 that receives a fastener (not shown) to secure the bracket 230 to the frame 78 of the bed 70. Each opening 242 is sized, shaped, and positioned to correspond with pre-existing opening(s) in the frame 78 of the bed 70 such that additional machining of the bed is not necessary. Likewise, the support arm 238 and the mounting arm 240 are configured to mimic known bed frame 78 geometry in order to facilitate mounting of the bracket 230 to the frame.

The DVT pump 220 is mounted to the base 232 of the bracket 230 by fasteners (not shown) that extend through one or more openings 252 in the base. Each opening 252 is sized, shaped, and positioned to correspond with pre-existing opening(s) in the DVT pump 220 such that additional machining of the pump is not necessary. The fasteners used to secure the DVT pump 20 to the base 232 may be security fasteners to prevent removal of the pump from the base. When the DVT pump 220 is mounted to the bracket 230, the pump abuts the retaining arms 244 and the support arm 238 to help retain the pump on the bracket. The base 232 of the bracket 230 may be angled relative to the mounting arm 240 such that the DVT pump 220, when mounted to the bed 70, is angled for easier visualization.

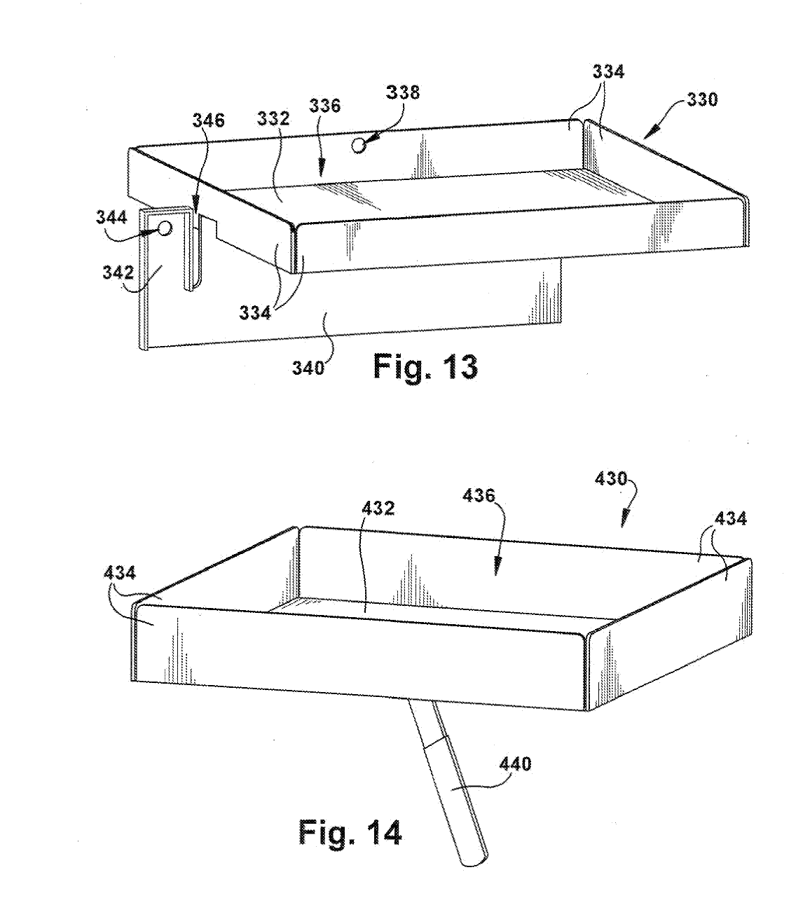

FIG. 13 illustrates a mounting bracket 330 for securing a DVT pump to a hospital bed 70 in accordance with another aspect of the present invention. The bracket 330 includes a generally rectangular base 332 and a plurality of walls 334 that extend away from the base and define an interior space 336. At least one of the walls 334 includes an opening 338 for receiving a security screw (not shown) in order to securely fasten the DVT pump to the bracket 330 to prevent the pump from being removed from the bracket once the pump is mounted to the bed 70 to prevent theft. The bracket 330 is constructed of a rigid material such as metal, plastic or combinations thereof.

A support arm 340 extends downwardly from the base 332. The support arm 340 may extend perpendicular to the base 332 or at any other angle relative to the base. A mounting arm 342 extends from the support arm 340 and substantially parallel to the support arm. At least one opening 344 extends through the mounting arm 342 and is configured to receive a fastener (not shown) for securing the bracket 330 to the hospital bed 70. A notch 346 may be formed in either the support arm 340 or the mounting arm 342 and is configured to receive part of the frame 78 of the bed 70 (not shown). In other words, the notch 346 helps to route the support arm 340 and the mounting arm 342 around pre-existing portions of the frame 78 of the bed 70 such that additional machining or alteration of the frame is not necessary to mount the DVT pump to the bed.

FIG. 14 illustrates a mounting bracket 430 for securing a DVT pump to a hospital bed 70 in accordance with another aspect of the present invention. The bracket 430 includes a generally rectangular base 432 and a plurality of walls 434 that extend away from the base and define an interior space 436. The bracket 430 is constructed of a rigid material such as metal, plastic or combinations thereof.

A mounting arm 440 extends downwardly and transversely from the base 432. At least one opening (not shown) extends through the mounting arm 440 and is configured to receive a fastener (not shown) for securing the bracket 430 to the hospital bed 70. The mounting arm 440 is configured to extend through and between pre-existing portions of the frame 78 of the bed 70 such that additional machining or alteration of the frame is not necessary to mount the DVT pump to the bed.

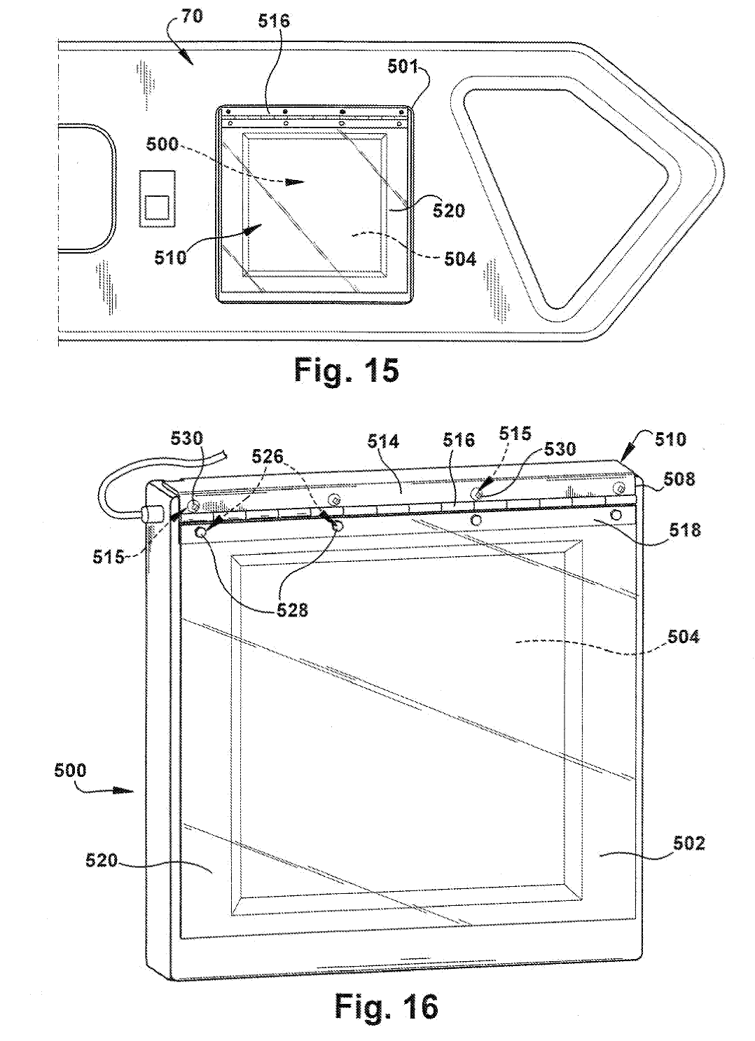

FIGS. 15-18 illustrate a protective device 510 for a touch screen control device 500 for a hospital bed 70 in accordance with another aspect of the present invention. The touch screen control device 500 may he positioned within a recessed portion 501 of the hospital bed 500 or mounted to the frame or other portion of the hospital bed. The control device 500 includes a front portion 502 including an interactive touch screen 504 for controlling operation of the bed 70. Since it is desirable to maintain functionality of the touch screen control device 500 during use and transport of the bed 70, the protective device 510 is configured to help protect the touch screen 504 from damage.

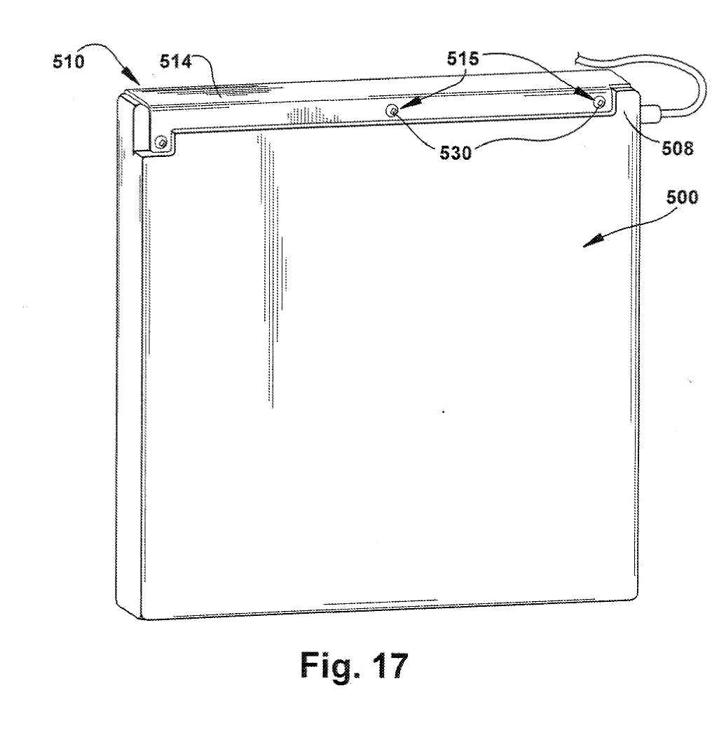

The protective device 510 includes a rigid frame 514 having a substantially U-shaped configuration that may be constructed of metal, plastic or combinations thereof. The frame 514 is configured to overlay and conform to the periphery of an upper portion 508 of the touch screen control device 500. Alternatively, the frame 514 may be overlay another portion of the periphery of the touch screen control device 500, e.g., the bottom portion or either side portion (not shown). The frame 514 includes a plurality of holes 515 (FIG. 17) for receiving fasteners 530 in order to secure the frame 514 to the touch screen control device 500.

An end of the frame 514 includes a hinge 516 that pivotally mounts a flange portion 518 to the frame 514. The hinge 516 includes a plurality of holes 526 for mounting a protective cover 520 to the hinge via a series of fasteners 528. The protective cover 520 has a generally rectangular shape and is sized to overlay a substantial portion or all of the touch screen 504 of the touch screen control device 500. The protective cover 520 may be constructed of a transparent or translucent material that allows visibility of the touch screen 504 while the cover overlays the touch screen. Alternatively, the cover 520 may be constructed of a material that is neither transparent nor translucent. In any case, the cover 520 is constructed of a durable, scratch-resistant material.

The cover 520 has a first position (FIG. 16) in which the cover overlays the front portion 502 and, more specifically, the touch screen 504 of the control device 500. In the first position, the cover 520 helps to protect the touch screen 504 from damage. If the cover 520 is constructed of a transparent material, the practitioner can still read the touch screen 504 of the control device 500 when the cover is in the first position.

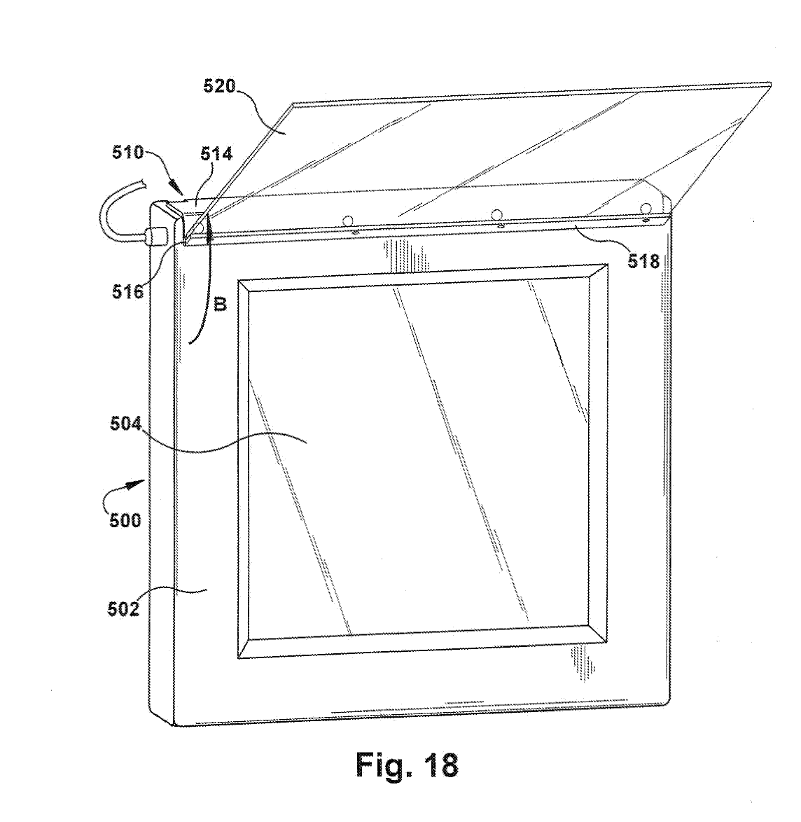

Since the protective cover 520 is secured to the hinge 516, the cover is pivotable relative to the frame 514. When it is desirable to use the touch screen 504, the cover 520 can be pivoted upwards and away from the touch screen as indicated by arrow B (FIG. 18) to a second position. Due to this construction, the protection device 510 affords an easy, effective means by which the touch screen control device 500 can be protected in the hospital environment while maintaining quick accessibility to the touch screen 504 for controlling operation of the hospital bed 70.

In an alternative embodiment of the protection device (not shown), a casing may be provided that slides from a protective position to a second position to allow an operator to access the controls. In addition to or in lieu of the sliding casing, an add-on may be provided that snaps onto the touch screen but allows access via a rigid flap (not shown).

From the above description of thee invention, those skilled in the art will perceive improvements, changes and modifications. Such improvements, changes and modifications within the skill of the art are intended to be covered by the appended claims. For example, although particular mounting positions for the DVT pump on the hospital bed have been described, it will be understood to those having ordinary skill that the mounting bracket may be shaped, configured or otherwise adapted to be mounted to any portion of the hospital bed frame in accordance with the present invention.

Having described the invention, the following is claimed:

1. A bracket for securing a pump having a plurality of fluid communication tubes and at least one pre-existing mounting opening to pre-existing openings in the frame of a hospital bed, the bracket comprising:
a base having at least one opening aligned with the at least one pre-existing mounting opening of the pump for securing the base to the pump; and
a mounting arm connected to the base and including at least one opening aligned with the at least one pre-existing opening in the hospital bed frame.

2. The bracket recited in claim 1 further comprising a support arm extending from the base and connecting the base to the mounting arm.

3. The bracket recited in claim 2, wherein the mounting arm extends substantially parallel to the base.

4. The bracket recited in claim 1 further comprising a second mounting arm, each of the mounting arms being connected to the base by a support arm.

5. The bracket recited in claim 4, wherein the base includes at least one opening for receiving the tubes of the pump.

6. The bracket recited in claim 4, wherein the mounting arms are symmetrically positioned about each end of the base.

7. The bracket recited in claim 1, wherein the base includes a plurality of walls defining an interior space for receiving the pump.

8. The bracket recited in claim 7, wherein the mounting arm extends downwardly from the base.

9. The bracket recited in claim 7 further comprising a support arm extending downwardly from the base and connecting the mounting arm to the base, wherein a notch is formed in one of the mounting arm and the support arm for routing the mounting arm and the support arm around pre-existing portions of the hospital bed frame.

10. The bracket recited in claim 1 further including a least one retaining arm for retaining the pump on the base.

11. A bracket for securing a pump having a plurality of fluid communication tubes and at least one pre-existing mounting opening to pre-existing openings in the frame of a hospital bed, the bracket comprising:
a base having at least one opening aligned with the at least one pre-existing mounting opening of the pump for securing the base to the pump;
a mounting arm including at least one opening aligned with the at least one pre-existing opening in the hospital bed frame; and
a support arm extending from the base and connecting the mounting arm to the base.

12. The bracket recited in claim 11, wherein the mounting arm extends substantially parallel to the base.

13. The bracket recited in claim 11 further comprising a second mounting arm connected to the base by a second support arm.

14. The bracket recited in claim 13, wherein the base includes at least one opening for receiving the tubes of the pump.

15. The bracket recited in claim 13, wherein the mounting arms are symmetrically positioned about each end of the base.

16. The bracket recited in claim 11, wherein the base includes a plurality of walls defining an interior space for receiving the pump.

17. The bracket recited in claim 16, wherein the mounting arm extends downwardly from the base.

18. The bracket recited in claim 11, wherein a notch is formed in one of the mounting arm and the support arm for routing the mounting arm and the support arm around pre-existing portions of the hospital bed frame.

19. The bracket recited in claim 11 further including a least one retaining arm for retaining the pump on the base.

20. An apparatus for protecting the touch screen of a touch screen control device comprising:
a substantially U-shaped frame configured to overlay the periphery of the touch screen control device;
a hinge secured to the frame and positioned adjacent to the touch screen; and
a protective cover secured to the hinge, the cover being pivotable relative to the frame from a first position overlying and protecting the touch screen to a second position in which the touch screen is exposed.
